(19) United States
(12) Patent Application Publication
(10) Pub. No.: US 2008/0232104 A1
(43) Pub. Date: Sep. 25, 2008

(54) Display Pedestal for Decorative Objects

(75) Inventors: Angela B. Freeman, West Jordan, UT (US); R. Brent Freeman, West Jordan, UT (US)

Correspondence Address: THORPE NORTH & WESTERN, LLP., P.O. Box 1219, SANDY, UT, 84091-1219, US

(73) Assignee: Accents for Elegance, LLC, West Jordan, UT (US)

(21) Appl. No.: 12/053,458

(22) Filed: Mar. 21, 2008

Related U.S. Application Data
(60) Provisional application No. 60/919,377, filed on Mar. 21, 2007.

(51) Int. Cl. F21V 21/32

(52) U.S. Cl. 362/250

(57) ABSTRACT

A display pedestal for decorative objects, wherein the display pedestal comprises various lighting features that function to enhance the viewable prismatic effect about the decorative object as displayed on the display pedestal. More specifically, the display pedestal comprises one or more interior light sources operable with one or more peripheral light sources, wherein both of the interior and peripheral light sources are selectively controlled. The interior lights function to illuminate the decorative object from its interior, or from the inside out. The peripheral light sources illuminate the outer surfaces of the decorative object, and are adjustable in one or more ways to optimize the angle of incidence on one or more outer surfaces of the decorative object. Combining the interior lights with the peripheral lights provides a synergistic relationship that enhances the prismatic effect.

### RELATED APPLICATIONS

This application claims the benefit of U.S. Provisional Application Ser. No. 60/919,377, filed Mar. 21, 2007, and entitled, “Display Pedestal for Decorative Objects,” which is incorporated by reference in its entirety herein.

### FIELD OF THE INVENTION

The present invention relates generally to display pedestals or stands for displaying decorative objects, and more particularly to rotating display pedestals designed to rotatably support a decorative object about a surface thereof

### BACKGROUND OF THE INVENTION AND RELATED ART

There are many display pedestals that exist in the art. These come in a variety of sizes and shapes, and are designed to provide a suitable display for a decorative object, such as a vase, a lamp, a collectible item, artwork, porcelain figurines, and various other types of decorative objects. However, many of these display pedestals lack the ability to provide a dynamic display that allows users to enhance and optimize the display of the item. Indeed, many prior related display pedestals provide rotating elements and one or more lights configured to illuminate at least a portion of the decorative object. However, it has been discovered that these are severely limiting in their ability to enhance the visual effects created about the decorative object, thus resulting in a less than stunning display.

Many prior related display pedestals provide interior lights that function to illuminate a decorative object (assuming it comprises a degree of transparency) from the inside out. However, these are typically stationary and relatively few in number. In addition, they all typically comprise the same type of light with no way to vary the intensity of the radiated light.

Based on the foregoing, it has been discovered that a display pedestal is needed that provides a much more dynamic display of a decorative object.

### SUMMARY OF THE INVENTION

In light of the problems and deficiencies inherent in the prior art, the present invention seeks to overcome these by providing a display pedestal for decorative objects, wherein the display pedestal comprises various lighting features that function to enhance the viewable prismatic effect about the decorative object as displayed on the display pedestal. More specifically, the display pedestal comprises one or more interior light sources operable with one or more peripheral light sources, wherein both of the interior and peripheral light sources are selectively controlled. The interior lights function to illuminate the decorative object from its interior, or from the inside out. The peripheral light sources illuminate the outer surfaces of the decorative object, and are adjustable in one or more ways to optimize the angle of incidence on one or more outer surfaces of the decorative object. Combining the interior lights with the peripheral lights provides a synergistic relationship that enhances the prismatic effect.

In accordance with the invention as embodied and broadly described herein, the present invention resides in a display pedestal for displaying a decorative object and for inducing a prismatic effect about the decorative object from light directed thereon, the display pedestal comprising a base having a housing defining an outer periphery, and a rotating element capable of continuous and bidirectional rotation about the housing, and of rotatably supporting the decorative object thereon; and a series of peripheral lights operable with the base and situated about the periphery, the peripheral lights each being configured to illuminate one or more exterior surfaces of the decorative object as the exterior surfaces pass through the light upon rotation of the decorative object, the peripheral lights each being selectively adjustable so as to manipulate the angle of incidence of the light on select exterior surfaces of the decorative object, and to enhance the prismatic effect about the decorative object.

The display pedestal further comprises at least one interior light situated within the outer periphery and configured to illuminate the decorative object from the inside out, wherein light from the at least one interior light combines with light from the peripheral lights to further enhance the prismatic effect.

The present invention also resides in a display pedestal for displaying a decorative object and for inducing a prismatic effect about the decorative object from light directed thereon, the display pedestal comprising a base having a housing defining an outer periphery, at least one rotating element adapted to provide continuous and bidirectional rotation of at least one decorative object about the housing, and to rotatably support the decorative object thereon, the rotating element comprising a reflective surface and at least one light passing component; and a series of peripheral lights operable with the base and configured to illuminate one or more exterior surfaces of the decorative object as the exterior surfaces pass through the light upon rotation of the decorative object, the peripheral lights each being selectively adjustable so as to manipulate the angle of incidence of the light on select exterior surfaces of the decorative object, and to enhance the prismatic effect about the decorative object; at least one interior light adapted to illuminate the decorative object from the inside out; and means for controlling and manipulating the rotating element, the peripheral lights and the interior light.

The present invention further resides in a method for creating a prismatic effect about a decorative object comprising supporting the decorative object about a base; causing an interior light to illuminate the decorative object from the inside out; and causing a peripheral light to illuminate an exterior of the decorative object, each of the interior and peripheral lights being selectively adjustable so as to manipulate the angle of incidence of the light on the decorative object, and to enhance the prismatic effect about the decorative object.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a generic block diagram generally depicting the various components of the present invention display pedestal;

FIG. 2 illustrates a perspective view of a display pedestal in accordance with one exemplary embodiment of the present invention;

FIG. 3 illustrates a partial side view of a display pedestal in accordance with another exemplary embodiment of the present invention;

FIG. 4 illustrates a partial side view of a display pedestal in accordance with still another exemplary embodiment of the present invention;

FIG. 5 illustrates a graph of the prismatic effect achieved by selectively activating the interior and/or peripheral light sources, and by varying the intensity of these;

FIG. 6 illustrates a perspective view of a display pedestal in accordance with still another exemplary embodiment of the present invention;

FIG. 7 illustrates a cut-away side view of the display pedestal of FIG. 6 taken along lines A-A; and

FIG. 8 illustrates a perspective view of a display pedestal in accordance with still another exemplary embodiment of the present invention, wherein the display pedestal comprises multiple rotating elements, each having corresponding peripheral lights operable therewith.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

The term “interior light” or “interior light source,” as used herein, shall be understood to mean at least one light or light source situated or positioned to illuminate the decorative object from the inside out. Interior lights may be integrally formed with the base and/or rotating element or a component thereof, lights that are either fixed or removably coupled to the base and/or rotating element or a component thereof, lights that are supported below a surface of the base and/or rotating element, or any combination of these. The types of light sources used for the various interior lights may vary depending upon the desired effect.

The term “peripheral light” or “peripheral light source,” as used herein, shall be understood to mean at least one light or light source situated or positioned to direct light onto one or more exterior surfaces of the decorative object being supported on the base. Peripheral lights may be integrally formed with the base and/or rotating element or a component thereof, lights that are either fixed or removably coupled to the base and/or rotating element or a component thereof, or any combination of these. The types of light sources used for the various peripheral lights may vary depending upon the desired effect.

The term “prismatic effect,” as used herein, shall be understood to mean the visual reflective effect induced about the decorative object by illuminating one or more external and/or internal surfaces of the decorative object with one or more of the interior and/or peripheral lights. Light from the interior and/or peripheral lights incident on the various surfaces of the decorative object is partially absorbed and partially reflected depending upon any number of factors, thus enabling a user to create different prismatic effects by manipulating the components of the display pedestal, and particularly the light from the various sources. The prismatic effect may be enhanced and optimized for a particular decorative object by employing one or a plurality of techniques made possible by the display pedestal, such as varying the number of lights on at a given time, manipulating the angle of incidence of light on a surface of the decorative object as provided by a specific light source, selectively adjusting the intensity of one or more lights, causing the decorative object to rotate in a continuous manner or in a bidirectional manner, rotating the decorative object at different speeds, providing lights of different color and selectively activating these, causing all or a portion of the lights to go on and off at specific times or different intervals.

The present invention describes a method and system for displaying a decorative object using a display pedestal having the capacity to create and enhance a prismatic effect about the decorative object. The present invention multi-directional, multi-purpose reflective display pedestal with its specially designed light system is specifically intended to enhance the reflective and prismatic effects and qualities of all types of decorative objects, such as leaded crystal, cut and regular glass and all works of art which will be displayed on it. This is accomplished using one or more of the available features of the display pedestal.

Generally, the display pedestal comprises a rotating element supported about an upper surface of the base, wherein the rotating element is configured to support the decorative object and to cause it to rotate with respect to the base. The rotating element and the upper surface may be reflective to redirect or reflect light incident thereon. The display pedestal further comprises one or more, and preferably a series of, interior lights that illuminate the decorative object from the inside out (assuming the decorative object is at least somewhat translucent), as well as a series of peripheral lights that direct light onto the exterior surfaces of the decorative object. Using any one of or a combination of these features, a stunning prismatic effect can be achieved, and also enhanced or optimized with each decorative object by manipulating the light sources in one or more ways. Using these concepts, any decorative object displayed on the display pedestal is beautified and enhanced from its normal appearance.

More specifically, the display pedestal imparts circular motion to the decorative object using a motorized multi-directional base having a rotating mirrored top or rotating element. Operable with the base are two at least two different types of light sources that may be selectively activated. An interior light source may utilize a mixture of multi-colored blue, red, yellow, green, violet and clear LED, incandescent or other types of lights that are set at specific angles ranging from 30 degrees up to 90 degrees. These may be supported in a planar or nonplanar, domed configuration within the interior of the base and the rotating element, and preferably at its center. The series of adjustable peripheral light sources may be provided around the periphery of the base, and may be adjustable to permit the user to vary or change the angle of incidence of the light being emitted from each light source. The peripheral light sources may be clear or colored LED or incandescent lights which have a flickering, pulsing or strobe capacity. In addition, the peripheral light sources may be fixed or removable with respect to the base, adjustable in height, adjusted to vary the angle of light incident on the decorative object, configured to provide different colors or intensities of light, etc.

Each of the interior and peripheral lights may further be controlled to dim or brighten using a dimmer function. As the rotating element of the base and the decorative object rotates, the light from both interior and peripheral light sources will create the initial prismatic effect, with colors of the decorative object being reflected back upon itself creating additional colors and patterns. Indeed, light tends to move in all directions about the object, which can create the appearance of a dripping fluid or flowing water as the light moves throughout the object. This may be enhanced by modifying the number, intensity and/or type of light from the interior or peripheral light sources.

As the rotating element of the base rotates, the decorative object being displayed will have light pass through it from the inside as well as from the outside, thus creating an appearance or effect as if the light were dancing up, down and across the object. The prismatic effect may be more pronounced in the event a leaded crystal object is displayed due to the special surface cutting and reflective properties of the leaded crystal.

The rotating element, each light source, etc. may have its own separate control, and may be controlled using an integrated wired control, or a wireless remote control. There may be an on/off switch for the motor which may also be configured to change the direction of rotation of the rotating element.

Each of the above elements, and others, is discussed in more detail below, with reference to the drawings.

The present invention provides several significant advantages over prior related display pedestals, some of which are recited here and throughout the following more detailed description. First, the present invention display pedestal provides peripheral light sources that may be used in conjunction with interior light sources to create and enhance the prismatic effect about a decorative object being displayed. Second, the peripheral lights may be adjustable so as to be able to vary the angle of incidence of the light as directed onto the decorative object. Third, the interior and peripheral lights may be selectively controlled and manipulated to provide different lighting effects, such as dimming, strobe, pulsing, alternating of color and white light, a more focused or broad spectrum light beam, and others.

Each of the above-recited advantages will be apparent in light of the detailed description set forth below, with reference to the accompanying drawings. These advantages are not meant to be limiting in any way. Indeed, one skilled in the art will appreciate that other advantages may be realized, other than those specifically recited herein, upon practicing the present invention.

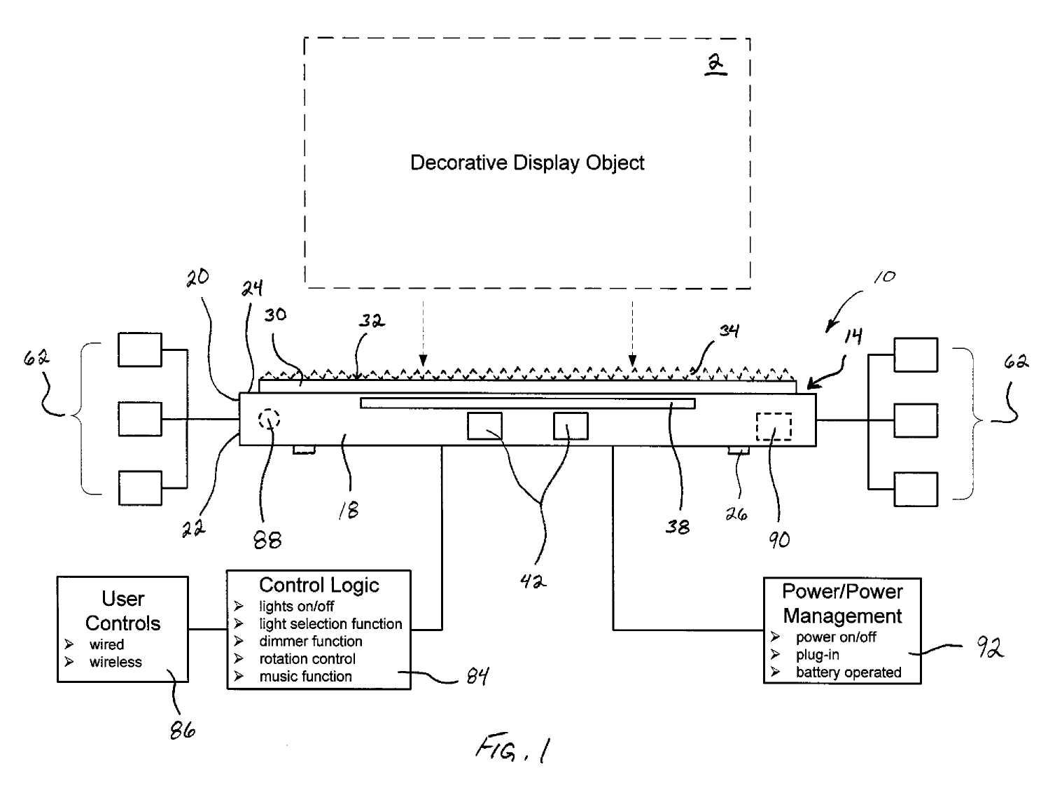

With reference to FIG. 1, illustrated is a block diagram of the present invention display pedestal, showing generally the various features and elements of the display pedestal in accordance with one exemplary embodiment. The display pedestal 10 is shown as comprising a base 14 having a housing 18 and an internal support structure (not shown) configured to support the several components of the base 14, as well as the decorative object 2. The housing and the support structure may be independent of one another, or integrally formed. The base 14 may also comprise one or more feet 26, such as rubber or plastic feet. The base 14 may be any size and may comprise any cross-sectional shape, taken laterally (or in other words as viewed from a top view), such as circular, square, rectangular, triangular, octagonal, arbitrary, and others. In addition, the base 14 may be formed of many different materials, such as plastic, ceramic, wood, metal, porcelain, stone or any combination of these.

The base 14 further comprises a periphery 20 which represents the outermost perimeter of the base 14 as measured from a central axis. In the embodiment shown, the periphery 20 is defined by an edge 22, which may comprise a linear or curved configuration. The edge 22 may further comprise other configurations, such as a stepped or sloped configuration. One skilled in the art will recognize that the base 14, and particularly the housing 18, may comprise many different sizes, shapes, and configurations, not to be limited in any way by those discussed herein and shown in the drawings.

The base 14 further comprises an upper or top surface 24 on which a rotating element 30 is supported. The rotating element comprises a motorized, multi-directional rotating element that may be caused to operate continuously in one direction or the other, or back and forth in a bi-directional manner for the purpose of rotating the decorative object 2 supported thereon, and for showcasing the various sides or surfaces of the decorative object 2. The rotating element 30 may be sized in accordance with the size and geometry of the base 14, wherein the rotating element 30 may be disposed about all or a portion of the upper surface 24 of the housing 18. In addition, the rotating element 30 may be formed from a variety of materials, such as plastic, metal, wood, etc.

The rotating element 30 preferably comprises a reflective upper surface 32 that functions to redirect or reflect light incident thereon upward and away from the base 14. In this manner, light from one or more light sources, namely the interior and/or peripheral light sources 42 and/or 62, respectively, as well as light reflecting off of the decorative object 2, that is incident on the rotating element 30, will be reflected off its surface 32 and towards the decorative object 2, thus further contributing to and enhancing the prismatic effect. The reflective surface 32 may be integrally formed with the rotating element 30, or it may comprise a thin sheeting that is applied to the rotating element 30.

The reflective surface 32 of the rotating element 30 may still further comprise a planar or nonplanar configuration. In a planar configuration, the reflective surface 32 will comprise a smooth surface, much like a common mirror. However, in a nonplanar configuration, the reflective surface may comprise a plurality of segments (that may be curved or planar) oriented on an incline with respect to one another to define a plurality of peaks and valleys, and to create a plurality of surfaces that reflect the light in different directions. Stated differently, the reflective surface 32 may comprise a plurality of individual inclined mirror-like elements (shown in dotted lines) 34 that are arranged at random or in a pattern. As light is received by the reflective surface 32 of the rotating element 30, the various individual segments 34 will cause the light to be reflected simultaneously in many different directions to again create a unique prismatic effect. The rotation of the rotating element 30 combined with either the planar or nonplanar configuration of the reflective surface 32 will create an even more dynamic reflection of light than application of the interior and/or peripheral light sources alone.

The rotating element 30 may further comprise a rim extending around its outer perimeter to provide a obstruction that helps hold the decorative object in place and from easily sliding off of the rotating element 30 and the base 14. Alternatively, the housing 18 may comprise a lip surrounding the perimeter of and extending above the rotating element 30.

The base 14 further comprises and supports means for rotating the rotating element 30, which means will generally comprise a motor and drive assembly. Means for rotating the rotating element 30 is represented by means 38 in FIG. 1. The details of means for rotating are not set forth herein, as the present invention contemplates the use of a variety of different types of motors and drive systems that are commonly known in the art. Suffice it to say, the rotating element 30 may be rotated using any known motor and drive system operable with the base 14. In addition, the means for rotating may be powered by batteries or by plugging the base 14 into an electrical outlet. In one embodiment, the means for rotating the rotating element 30 may comprise one or more bearings or other members that facilitate more smooth, efficient rotation of the rotating element 30. The rotating element 30 may be seated directly onto the bearings, or a spacer or intermediate element may be used. The use of bearings will also permit larger, heavier decorative objects to be displayed using a smaller motor without straining the motor.

The display pedestal 10 further comprises one or more interior light sources or lights, represented by lights 42 supported within the base 14. As indicated above, interior lights 42 are positioned within or interior to the periphery 20 of the housing 18, and preferably about the central axis of the base 14, and are sized, positioned, and configured to illuminate the decorative object 2 from the inside out. As such, housing 18 and the rotating element 30 are configured to permit light from the interior lights 42 to pass therethrough, or to comprise a light passing element or component. This may be accomplished by providing a transparent or translucent section that permits the passage of light, or one or more recesses or apertures formed in the housing 18 and/or the rotating element 30. In one exemplary embodiment, the interior lights 42 will be supported in a recess or opening in the housing below the reflective surface 32 of the rotating element 30 so as to not interfere with the decorative object 2 as supported on the rotating element 30.

The interior lights 42 may comprise any number and type, and may be located at different positions and oriented on different angles to create different prismatic effects of different intensities. For example, the interior lights 42 may comprise colored lights, white lights, black or UV lights, and any combination of these. The interior lights 42 may be of any type, such as, but not limited to, light-emitting diodes (LEDs), organic light-emitting diodes (OLEDs), incandescent, halogen, laser, neon, fluorescent, etc., and any combination of these. The interior lights 42 may be supported on a single planar surface, or about a concaved or convex surface, such as a domed surface so configured within the housing 18 of the base 14.

The display pedestal 10 further comprises a series of peripheral lights or light sources 62 that are operable with the base 14, and that are supported on, within, or about the periphery 20 of the base 14. The peripheral lights function to direct light onto one or more exterior surfaces of the decorative object 2. These may be operated alone or in conjunction with the interior lights 42 to create more dynamic prismatic or other visual effects about the decorative object 2. The peripheral lights 62 are physically supported about the base 14, and may be several in number, such as to extend around the entire periphery 20 of the base 14, thus allowing the entire outer or exterior surface of the decorative object 2 to simultaneously be illuminated.

Like the interior lights 42, the peripheral lights 62 may comprise any number and type, and may be located at different positions and oriented on different angles to create different prismatic effects about the decorative object 2. The peripheral lights 62 may further be adjustable in one or more degrees of freedom so as to enable a user to adjust the angle of incidence of the light upon the decorative object. In addition, the peripheral lights 62 may be adapted to adjust in height, such as with the use of flex lights formed from one or more extension sections capable of selectively extending and collapsing. Preferably, each of the peripheral lights 62 will be configured to provide both translational and rotational adjustment, with adjustment in the x,y, and/or z spatial direction being combined with rotational adjustment within a 0°-180° range, and preferably within a 0°-360° range, of motion to permit the peripheral lights 62 to direct light at any angle, and along different paths. One or both of translational and rotational adjustment will also provide the ability to focus the beams of light along any part of the exterior surface of the decorative object 2 from the peripheral lights 62, or to any surrounding objects that are not supported on the base 14 (e.g., an adjacent decorative object) as desired. Providing the ability to vary the height of the peripheral lights may further increase the capability of these lights to enhance the overall prismatic effect.

The display pedestal 10 may further comprise control logic, shown generally as control logic 84. Of course, the display pedestal 10 may be configured simply with all interior and peripheral lights 42 and 62, respectively, as well as the rotating element 30, becoming active when the power to the display pedestal 10 is turned on. However, the present invention contemplates the display pedestal 10 as comprising multiple selective control functions that will permit a user to control the various components of the display pedestal. For example, in one aspect, the control logic may be configured to facilitate selective on/off control of both the interior lights 42 and the peripheral lights 62. Therefore, any number or group or different types of interior lights may be selectively activated or turned on. Likewise, any number or group or different types of peripheral lights may be selectively activated or turned on. The duration of activation may also be controlled, with the control logic being able to facilitate strobe or pulsing of the lights at various frequencies. The ability to selectively activate and deactivate certain lights at certain times will allow a user to activate colored lights, LED lights, and any others to vary and enhance the prismatic effect about the decorative object.

In another aspect, the control logic 84 may be configured to facilitate dimming and brightening of any desired number or group of lights. Appropriate dimmer circuitry may be incorporated into the base 14, and made operable with the interior and/or peripheral lights 42 and 62, respectively.

The control logic 84 may also be configured to facilitate control of the rotation element 30, such as its direction of travel, its speed, the starting and stopping, providing interval rotation, the timing of direction changes, etc.

The display pedestal 10 may further comprise a music function, with the control logic 84 further being configured to facilitate, the playing of music. The music component is illustrated generally as music component 90 supported within the housing 18 of the base 14.

The control logic 84 is controlled and manipulated by the user via one or more user controls 86, which may be integrally formed into the base 14 for physical manipulation by a user and/or located on a wireless transmitter or remote control that transmits a command signal to a signal receiver 88 located on the base 14, either of which embodiments enable the user to cause the control logic 84 to carry out a desired command. The control logic 84 may be made to be as sophisticated as desired, for the purpose of controlling one or more aspects of the display pedestal 10. Other types of aspects may be controlled by the control logic 84 other than those specifically recited herein. As such, one skilled in the art may recognize other controllable aspects of the display pedestal 10, which aspects are intended to be covered by the present invention and the associated claims.

The display pedestal still further comprises a power/power management component 92, wherein the display pedestal 10 may be operated on battery power, or by plugging it in to a standard electrical outlet. The power management component 92 may manage the power to the display pedestal 10, with power being needed to activate the interior and peripheral lights 42 and 62, as well as to rotate the rotating element 30.

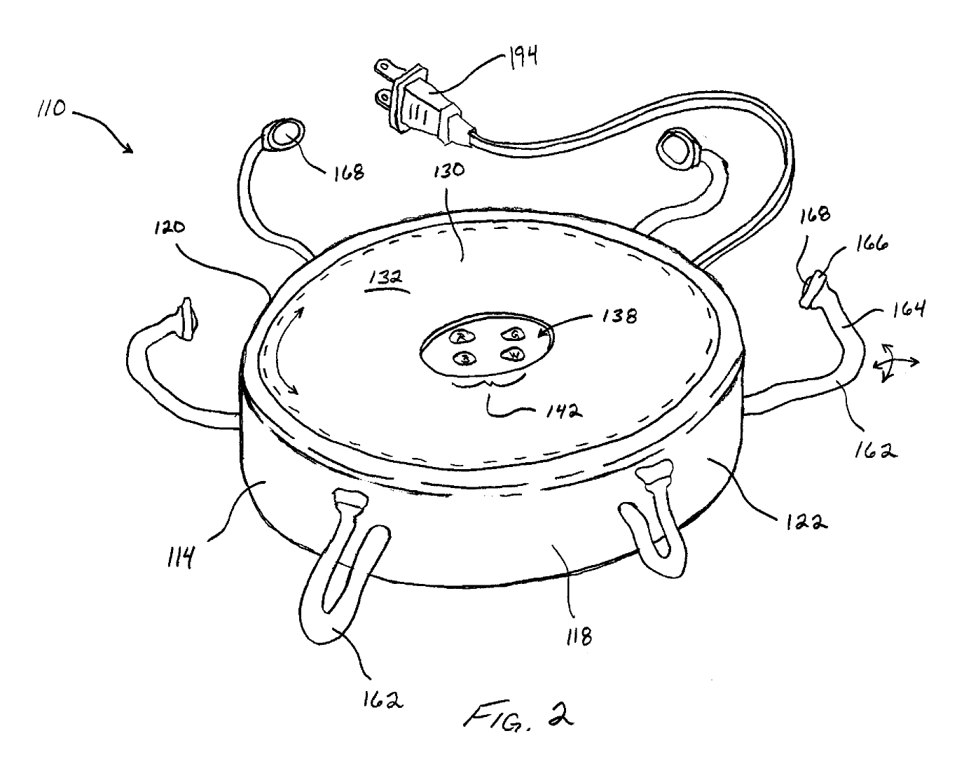

With reference to FIG. 2, illustrated is a display pedestal in accordance with one specific exemplary embodiment of the present invention. As shown, the display pedestal 110 comprises a base 114 having a cylindrical housing 118 with an edge 122 that defines a periphery 120. The display pedestal 110, and particularly the base 114, further comprises a rotating member 130 that is rotatably supported about the housing 118 and that is operable with the housing 118 to rotatably support and display a decorative object (not shown). The rotating member 130 comprises an opening 138 formed in its surface 132 to facilitate the passage of light through the rotating member 130 radiating from the interior lights 142.

The display pedestal 110 further comprises interior lights 142, shown as being present in a cluster of four lights, all within the same or a common plane that is below the plane of the surface 132 of the rotating element 130. The interior lights 142 should be seated far enough below the rotating element 130 so as to not interfere with the decorative object once placed on top of the surface 132. As stated above, the interior lights 142 are able to illuminate the interior of the decorative object, and contribute to the overall prismatic effect about the object by lighting the object from the inside out. The interior lights 142 are shown as comprising different colors, namely red, green, blue and white, each of which may be selectively activated one at a time or simultaneously to provide different lighting effects.

The display pedestal 110 further comprises peripheral lights 162, shown as being six in number, that are spaced evenly apart and that extend around the periphery 120 of the base 114, and that are electrically coupled to the power/power management component (not shown, but see FIG. 1) and also the control logic component (not shown, but see FIG. 1). The peripheral lights 162 each comprise a flexible support member 164 that is operably coupled to the base 114 around the edge 122 of the housing 1 18. The flexible support member 164 is configured to flex and bend in multiple degrees of freedom and to retain its manipulated position so as to permit selective adjustment of the head 166 that is positioned about a distal end of the flexible support member 164, which head 166 comprises a socket operable to receive a light 168 therein, such as a 360° circumferential adjustable eyeball light. In other words, the flexible support member 164 is formed of an inelastic, flexible material that maintains its position until moved again much like a wire. Flexible support members are commonly known in the art, many of which may be modified to be operable within the application as intended herein.

In one aspect, the light 168 supported within the head 166 may be fixed or stationary. In another aspect, the head 166 may also comprise structure that rotatably and/or pivotally supports the light 168, thus providing the peripheral light 162 with additional adjustment capabilities. Indeed, the peripheral lights 162 may each be manipulated into a proper position by first manipulating the flexible support member 164 to position the head 166, and subsequently manipulating the light 168 within the socket of the head 166 to achieve a desired angle of incidence of light on one or more external surfaces of the decorative object as radiating from the peripheral lights 162. Adjusting the actual light 168 within the socket of the head 166 may require the user to apply a small amount of pressure to the light 168 using a finger or other object, which pressure will cause the light 168 to move in any direction and to the desired position. The peripheral lights 162 may also be positioned to direct light onto other items in close proximity to the display pedestal 1 10.

The display pedestal 110 further comprises a plug 194 operable with the power/power management component that allows the display pedestal 110 to be plugged into a standard electrical outlet for supplying the necessary power to the components of the display pedestal 1 10. A similar battery powered system may also be used to provide the necessary power to the components of the display pedestal 1 10.

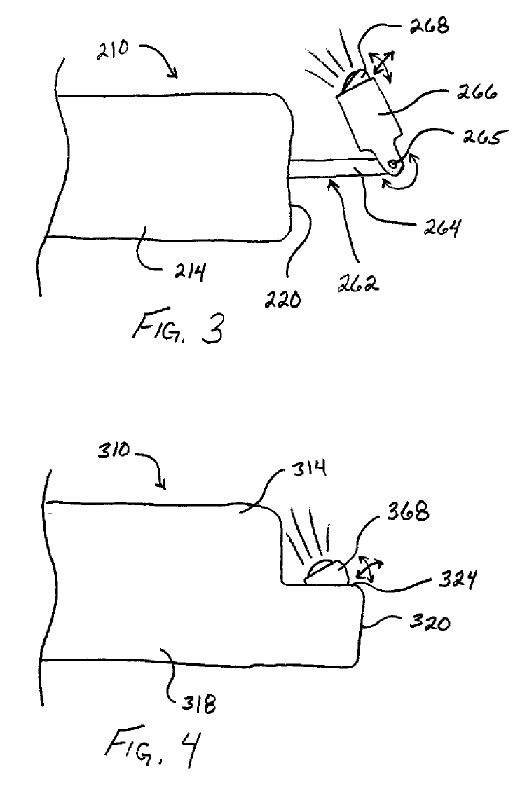

With reference to FIG. 3, illustrated is a partial side view of a display pedestal in accordance with another exemplary embodiment of the present invention. In this particular embodiment, the display pedestal 210 comprises a series of peripheral lights, with only one being shown, namely peripheral light 262. The peripheral light 262 comprises a rigid support member operable with the base 214 and coupled to and extending outward from the periphery 220 of the base 214. The peripheral light 262 further comprises a head 266 pivotally coupled to the rigid member 264 about pivot point 265. The head 266 comprises a socket that supports the light 268, which is shown as comprising an eyeball light that is itself adjustable. The head 266 may be pivoted about the rigid member 264 within a range of 00 and 1800, thus allowing a user to change the angle of incidence of radiated light on one or more external surfaces of the decorative object (not shown) being displayed on the display pedestal 210. In another similar embodiment, the rigid member 264 may be rotatably coupled to the base 214 to permit an additional degree of freedom.

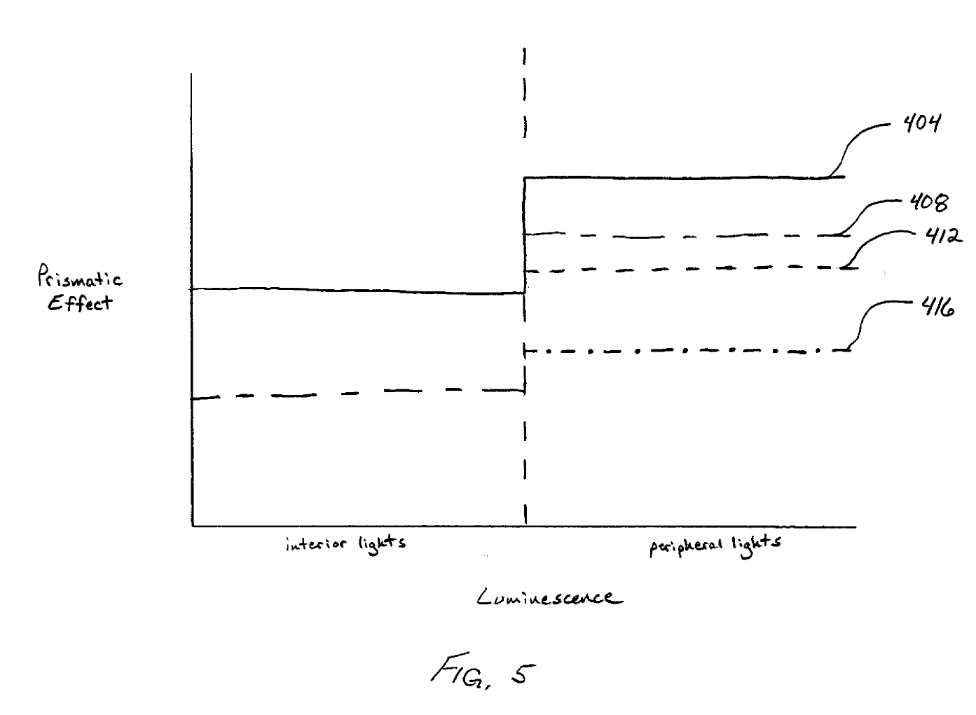

With reference to FIG. 4, illustrated is a partial side view of a display pedestal in accordance with another exemplary embodiment of the present invention. In this particular embodiment, the display pedestal 310 comprises a series of peripheral lights, with only one being shown, namely peripheral light 362. The peripheral light 362 is shown as being supported about a ledge 224 formed in the housing 318 of the base 314, which ledge extends all the way around the base 314. A series of lights 368 are operably and adjustably supported about the ledge 224 in a similar manner as described above with respect to the other embodiments. In this case, the lights 368 may be selectively adjusted to vary the angle of incidence of radiated light on one or more external surfaces of the decorative object.

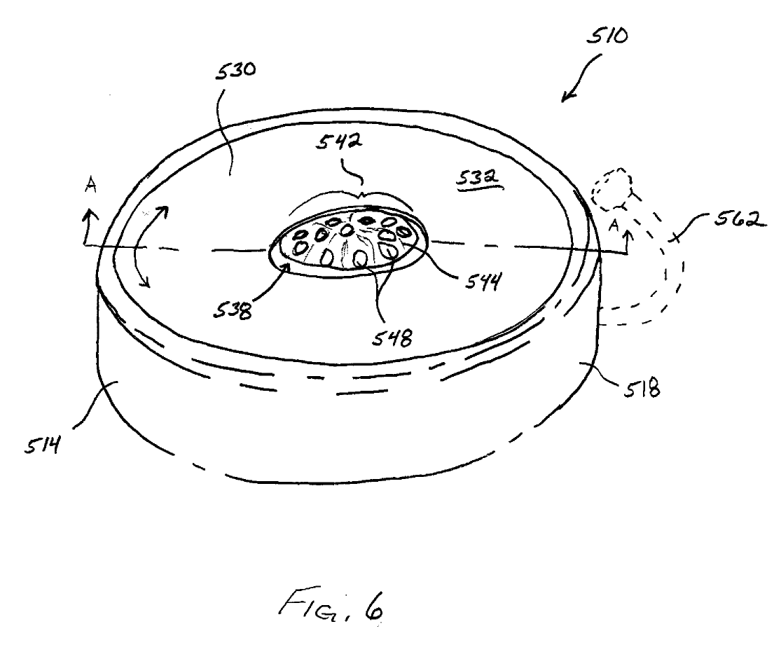

With respect to FIG. 5, illustrated is a graph depicting the change in prismatic effect by selectively activating one or both of the interior and peripheral light sources, as well as controlling the intensity of these light sources. As shown, line 404 represents the prismatic effect about the decorative object with the interior and peripheral light sources being activated and caused to illuminate with full power. Line 408 represents the prismatic effect with the interior light source(s) being somewhat dimmed and the peripheral light sources being activated on full power. Line 412 represents the prismatic effect with the interior light source(s) being activated on full power, and the peripheral light sources being somewhat dimmed. Line 416 represents the prismatic effect with the interior light source(s) being somewhat dimmed and the peripheral light sources also being somewhat dimmed. As can be seen, selecting different light sources, and also varying their intensities, will significantly affect the viewable prismatic effect about a particular displayed decorative object.

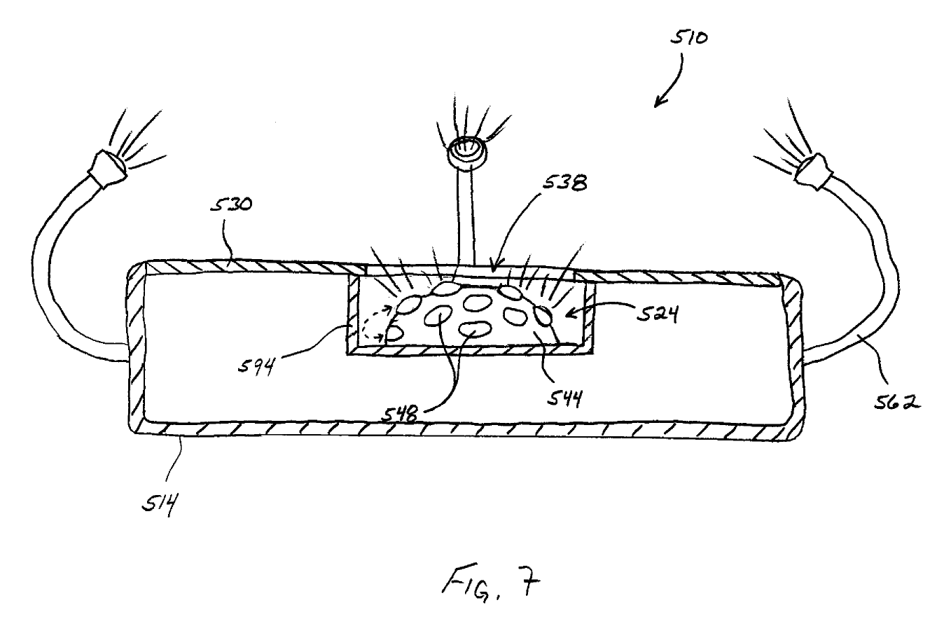

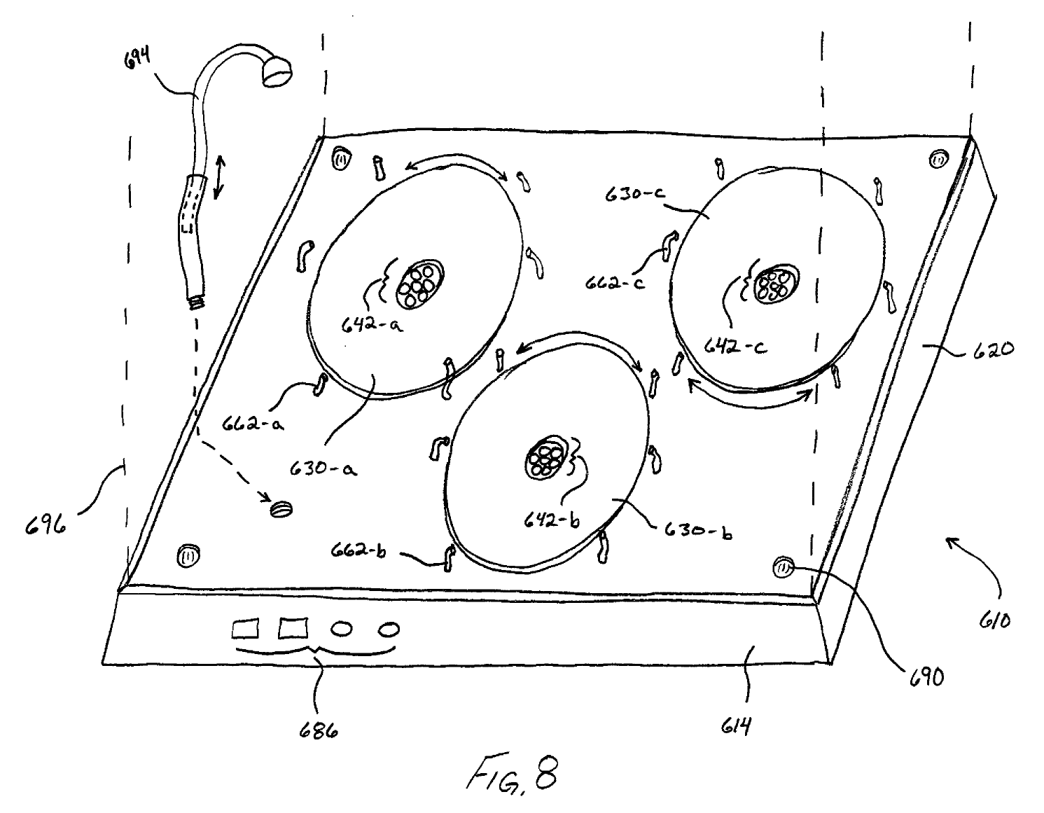

With reference to FIGS. 6 and 7, illustrated is a display pedestal in accordance with still another exemplary embodiment of the present invention. The display pedestal 510 is similar in many respects to those discussed above. However, in this particular embodiment, the display pedestal 510 comprises a support structure 520 formed in the base 514, and more particularly the housing 518, which support structure defines a recess 524 configured to support, and in some embodiments rotatably support, a domed structure 544 designed and configured to support one or more lights 548 thereon. The domed structure 544 and the lights 548 function to makeup the interior light source 542 of the display pedestal 510. The rotating member 530 comprises an opening 538 to permit light to pass therethrough, and into the interior of the decorative object (not shown) supported on the base 514. The domed structure 544 may comprise different sizes and curvature configurations. The domed structure 544 and the lights 548 operable therewith preferably do not extend upward beyond the surface 532 of the rotating element 530 so as to not interfere with the decorative object. In addition, the domed structure may be configured to rotate to cause rotation of the lights 548 supported thereon. The lights 548 may comprise all the same types and colors, or they may be comprised of different types and different colors.

Providing a domed structure has many different advantages. First, the lights may be easily oriented on multiple different inclines with respect to the surface 532 of the rotating element 530. Indeed, as can be seen, lights near the bottom of the domed structure 544 are oriented on a more gradual angle with respect to the surface 532 of the rotating element 530 than are those lights disposed near the top or apex of the domed structure 544, which are oriented on a relatively steeper angle. Providing interior lights on multiple inclines will function to broadly disperse light into the interior of the decorative object, and onto many different parts of its interior surfaces. Second, the interior of the decorative object may be illuminated with light on multiple different incidence angles, thus adding to the overall prismatic effect. These angles of incidence, and the overall prismatic effect, may be changed by selectively activating and deactivating certain lights 548 supported on the domed structure 544. In addition, the prismatic effect may be altered by varying the intensity of the lights 548.

The domed structure 544 may be operably supported within the housing 518 using any known means in the art.

With reference to FIG. 8, illustrated is a display pedestal in accordance with still another exemplary embodiment of the present invention. In this particular embodiment, the display pedestal 610 comprises a large base 614 capable of supporting multiple rotating elements, shown as rotating elements 630-a, 630-b and 630-c, each of which may support and display a decorative object. Each of the rotating elements may also comprise an interior light source, shown as light sources 642-a, 642-b and 642-c, respectively. In addition, each rotating element may comprise a series of peripheral light sources, shown as light sources 662-a, 662-b and 662-c, respectively. The interior and peripheral light sources, along with the rotating elements may be configured to function in a similar manner as discussed above. As such, the discussion above is incorporated herein, wherein appropriate. Although the peripheral lights are not necessarily beyond the periphery 620 of the base 614, they are still beyond the perimeter of the individual rotating elements, thus allowing the peripheral lights to direct light onto the decorative objects in an intended manner as also discussed above. The peripheral lights may be caused to direct light onto any one of the rotating elements operable with the display pedestal, not just the immediately adjacent rotating element. As such, a single decorative object may receive light thereon from one or more peripheral lights surrounding a rotating element that is not supporting that particular decorative object.

FIG. 8 further illustrates different types of peripheral light sources. Specifically, FIG. 8 illustrates a plurality of peripheral lights 690 integrally formed within the base 614. Any number of these may be used positioned at different locations around the base. In the embodiment shown, four peripheral lights are shown as being integrally formed with the base and positioned in the corners of the base. Peripheral lights 690 may comprise various types, such as LED, halogen, incandescent, etc. FIG. 8 further illustrates peripheral lights 694 in the form of flex lights formed from one or more collapsible segments that permit the height of the bulb of the flex light to be adjusted as desired. This may be advantageous if it is desired to illuminate the decorative object from the top down. In addition, FIG. 8 illustrates peripheral lights 694 as being removably coupled to the base 614, thus permitting their selective attachment and removal depending upon the desired effect. As one skilled in the art will recognize, removably lights are not limited to the flex lights shown herein. Indeed, any of the peripheral lights operable with the base may be removable, adjustable, etc.

The display pedestal 610 further comprises user controls 686, shown as buttons and/or knobs on the base 614. However, as indicated above, the various components of the display pedestal may be controlled wirelessly using a hand-held remote control unit.

Finally, the display pedestal 610 may comprise a transparent enclosure 696 operable to fit over the base 614 to enclose the rotating elements and the decorative objects supported thereon. The enclosure itself may comprise one or more lights operable therewith to illuminate one or more exterior surfaces of the decorative objects. The transparent enclosure 696 will most likely be formed from glass or a clear plastic material. In addition, there may be included means for retaining the enclosure 696 and/or means for securing the enclosure 696 about the base 614. In one exemplary embodiment, the transparent enclosure may comprise UV or black lights supported along the interior sides or top, which black lights may be selectively activated and used alone or in conjunction with the interior and/or peripheral lights on the base. In addition, various decorative items may be placed or supported within the enclosure about the base to react with the black lights, such as a phosphorescent or other item that will give off a glowing effect.

One alternative to providing multiple rotating elements in a single display pedestal is situating multiple individual display pedestals in close proximity to one another. They may be caused to rotate in different directions, one or more peripheral lights from one display pedestal may be used to illuminate a decorative object supported on another, etc.

It is noted herein that different types of decorative objects will provide a more dynamic and animated prismatic effect. Specifically, it is noted that leaded crystal objects will provide a more dynamic and animated prismatic effect over regular glass objects. This is in part due to the lead content contained within the crystals in combination with the plurality of different cuts that are often present within the exterior surface(s) of such objects. Optimizing the display pedestal for a leaded crystal object will effectively help explode the prismatic affect about that object. However, in any event, it is contemplated that the prismatic effect may be enhanced and even optimized for each particular decorative object being displayed simply by manipulating one or more operating parameters, such as the type of lights that are caused to be active, the intensity of these lights, the color of lights caused to be activated and their intensity, the rotation of the rotating member (e.g., continuously in one direction, in alternating directions, or stationary), etc.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

What is claimed and desired to be secured by Letters Patent is:

1. A display pedestal for displaying a decorative object and for inducing a prismatic effect about said decorative object from light directed thereon, said display pedestal comprising:
a base having a housing defining an outer periphery, and a rotating element capable of continuous and bidirectional rotation about said housing, and of rotatably supporting said decorative object thereon; and
a series of peripheral lights operable with said base and configured to illuminate one or more exterior surfaces of said decorative object as said exterior surfaces pass through said light upon rotation of said decorative object,
said peripheral lights each being selectively adjustable so as to manipulate the angle of incidence of said light on select exterior surfaces of said decorative object, and to enhance said prismatic effect about said decorative object.

2. The display pedestal of claim 1, further comprising at least one interior light situated within said outer periphery and configured to illuminate said decorative object from the inside out, wherein light from said at least one interior light combines with light from said peripheral lights to further enhance said prismatic effect.

3. The display pedestal of claim 2, wherein said interior light is supported about a domed structure operable with said base.

4. The display pedestal of claim 3, wherein said domed structure and said interior light supported thereon are positioned below a surface of said rotating element so as to permit said decorative object to be placed directly over said domed structure, said rotating element comprising one of an aperture and a translucent section to permit light from said interior light source to illuminate said decorative object from the inside out.

5. The display pedestal of claim 1, wherein said rotating element of said base comprises a reflective surface so as to reflect light incident thereon away from said base.

6. The display pedestal of claim 5, wherein said reflective surface is nonplanar, and comprises a plurality of reflective segments oriented on an incline with respect to a horizontal upper surface of the base.

7. The display pedestal of claim 1, wherein said base comprises a support structure independent of said housing.

8. The display pedestal of claim 1, wherein said rotating element is rotatably coupled to said base, and rotates independent of said housing.

9. The display pedestal of claim 1, wherein said rotating element comprises a rim adapted to help maintain said decorative object in place about said rotating element.

10. The display pedestal of claim 1, wherein said peripheral lights are adjustable within multiple degrees of freedom.

11. The display pedestal of claim 1, wherein said peripheral lights are capable of both translational and rotational adjustment.

12. The display pedestal of claim 1, wherein said peripheral lights are removably coupled to said base so as to facilitate varying the number of peripheral lights used at any given time.

13. The display pedestal of claim 1, wherein said peripheral lights comprise means for extending and collapsing that enables said peripheral lights to adjust in height.

14. The display pedestal of claim 1, wherein said peripheral lights are integrally formed with the base.

15. The display pedestal of claim 1, further comprising means for rotating said rotating element.

16. The display pedestal of claim 15, further comprising bearings operable with said means for rotating, said bearings facilitating enhanced efficiency within the rotation of said rotating element.

17. The display pedestal of claim 1, wherein at least one of said base and said rotating element comprises a transparent or translucent section that permits the passage of light therethrough, to facilitate illumination of said decorative object from the inside out via said interior lights.

18. The display pedestal of claim 1, wherein said interior lights are supported in a recess or opening in the housing below said reflective surface of said rotating element so as to not interfere with said decorative object as supported on said rotating element.

19. The display pedestal of claim 1, further comprise control logic configured to permit a user to control and manipulate various aspects of said display pedestal.

20. A display pedestal for displaying a decorative object and for inducing a prismatic effect about said decorative object from light directed thereon, said display pedestal comprising:
a base having a housing defining an outer periphery,
at least one rotating element adapted to provide continuous and bidirectional rotation of at least one decorative object about said housing, and to rotatably support said decorative object thereon, said rotating element comprising a reflective surface and at least one light passing component; and
a series of peripheral lights operable with said base and configured to illuminate one or more exterior surfaces of said decorative object as said exterior surfaces pass through said light upon rotation of said decorative object, said peripheral lights each being selectively adjustable so as to manipulate the angle of incidence of said light on select exterior surfaces of said decorative object, and to enhance said prismatic effect about said decorative object;
at least one interior light adapted to illuminate said decorative object from the inside out; and
means for controlling and manipulating said rotating element, said peripheral lights and said interior light.

21. A method for creating a prismatic effect about a decorative object comprising:
supporting said decorative object about a base;
causing an interior light to illuminate said decorative object from the inside out;
causing a peripheral light to illuminate an exterior of said decorative object, each of said interior and peripheral lights being selectively adjustable so as to manipulate the angle of incidence of said light on said decorative object, and to enhance said prismatic effect about said decorative object.

22. The method of claim 21, further comprising rotating said decorative element to create a dynamic surface thereof, and to enhance said prismatic effect.

23. The method of claim 21, further comprising manipulating at least one of said interior and said peripheral lights to enhance said prismatic effect.

24. The method of claim 21, further comprising configuring a surface of a rotating element to be nonplanar so as to provide a plurality of inclined surfaces capable of reflecting light onto said decorative object.

25. The method of claim 24, further comprising supporting said interior light about a domed structure operable with said base, wherein said domed structure and said interior light supported thereon are positioned below a surface of said rotating element so as to permit said decorative object to be placed directly over said domed structure, said rotating element comprising one of an aperture and a translucent section to permit light from said interior light source to illuminate said decorative object from the inside out
